(19) United States
(12) Patent Application Publication
(10) Pub. No.: US 2019/0377240 A1
(43) Pub. Date: Dec. 12, 2019

(54) VEHICLE CAMERA LENS PROTECTIVE COVER

(71) Applicants: Phyllis Florence Lowe, Waukee, IA (US); Wayne Richard Feldhacker, Creston, IA (US)

(72) Inventors: Phyllis Florence Lowe, Waukee, IA (US); Wayne Richard Feldhacker, Creston, IA (US)

(21) Appl. No.: 16/434,120

(22) Filed: Jun. 6, 2019

Related U.S. Application Data
(60) Provisional application No. 62/681,628, filed on Jun. 6, 2018.

(51) Int. Cl. G03B 11/04; H04N 5/225; G03B 17/55; B60R 11/04

(52) U.S. Cl. CPC G03B 11/043; H04N 5/2251; B60R 2011/0043; B60R 11/04; G03B 17/55

(57) ABSTRACT

A vehicle camera lens protective cover structured and arranged to open in any direction that will improve protection, while allowing the camera to telescope out, if necessary, for a better wide-angle view.

### CROSS-REFERENCE TO RELATED APPLICATION

The present application is related to and claims priority from prior provisional application Ser. No. 62/681,628, filed Jun. 6, 2018 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of lens protective covers and more specifically relates to a vehicle camera lens protective cover.

### 2. Description of the Related Art

Keeping your eyes on the road is safer when your vehicle's electronic eyes are clear and working correctly. A backup camera (also called a reversing camera or rear-view camera) is a special type of video camera. It is produced specifically for the purpose of viewing the area at the rear of a vehicle. This video camera aids in backing up and alleviates the rear blind spot. It is specifically designed to avoid a backup accident of any kind. The area directly behind vehicles has been described as a “killing zone” due to the associated carnage. Backup cameras are usually connected to the vehicle head unit display. A need exists for a Backup Camera Lens Cover to keep the camera vision clear of all debris.

The design of a backup camera is distinct from other cameras in that the image is horizontally flipped so that the output is a mirror image. This is necessary because the camera and the driver face opposite directions, and without it, the camera's right would be on the driver's left and vice versa. A mirrored image makes the orientation of the display consistent with the physical mirrors installed on the vehicle. A backup camera typically sports a wide-angle or fisheye lens. While such a lens spoils the camera's ability to see far away objects, it allows the camera to see an uninterrupted horizontal path from one rear corner to the other. The camera is typically pointed on a downward angle. This enables the camera to view potential obstacles on the ground, or behind the vehicle as well as the position of approaching walls, docks, and other things viewed as a possible safety issue. Again, a clear lens is very important to maintain a safe picture on the cameras. Therefore, a cover is also important as this lens is located in an area that is subjected to dirt, mud and other elements that distort the camera picture.

Ideally, a Vehicle Camera Lens Protective Cover should be user-friendly and safe in-use and yet would operate reliably and be manufactured at a modest expense. Thus, a need exists for a vehicle camera lens protective cover structured and arranged to open in any direction that will improve protection, while allowing the camera to telescope out, if necessary, for a better wide-angle view and to avoid the above mentioned problems.

### BRIEF SUMMARY OF THE INVENTION

In view of the foregoing disadvantages inherent in the known lens protective covers art, the present invention provides a novel Vehicle Camera Lens Protective Cover. The general purpose of the present invention, which will be described subsequently in greater detail is to provide a vehicle camera lens protective cover structured and arranged to open in any direction that will improve protection, while allowing the camera to telescope out, if necessary, for a better wide-angle view.

A vehicle camera lens protective cover comprising: a cover including a base part and a shutter part; a sensor; a motor; and a heater operably connected to the cover and the motor to defrost the shutter part and the motor prior to opening. Wherein the sensor is operably connected to receive the signal to open or close the shutter part of the cover. Wherein the motor is controllable by the sensor and operably connected to the shutter part of the cover to open or close the shutter part according to the signal received by the sensor. Wherein the heater is controllable by the signal received by the sensor. Wherein the signal received by the sensor to open the shutter part indicates the user's vehicle is in reverse, and wherein the signal received by the sensor to close the shutter part indicates the user's vehicle is no longer in reverse. Wherein the heater operates immediately upon receipt of the open signal or the close signal by the sensor, and wherein the motor operates to open the shutter part or close the shutter part three or four seconds after receipt of the open signal or close signal by the sensor, so that the shutter part and motor are heated by the heater prior to opening or closing the shutter part. Wherein the cover is color matched to the user's vehicle.

The present invention holds significant improvements and serves as a Vehicle Camera Lens Protective Cover. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, the Vehicle Camera Lens Protective Cover, constructed and operative according to the teachings of the present invention.

FIG. 1 shows a perspective view illustrating a cover and a shutter part of the Vehicle Camera Lens Protective Cover according to an embodiment of the present invention.

FIG. 2 is a perspective view illustrating another view of the cover including the base part, the shutter part, and a user's vehicle's camera lens of the Vehicle Camera Lens Protective Cover according to an embodiment of the present invention of FIG. 1.

FIG. 3 is a perspective view illustrating a user's vehicle's camera lens having the cover including a base part of the Vehicle Camera Lens Protective Cover according to an embodiment of the present invention of FIG. 1.

FIG. 4 is a perspective view illustrating a sensor of the Vehicle Camera Lens Protective Cover according to an embodiment of the present invention of FIG. 1.

FIG. 5 is a perspective view illustrating the cover including a base part the Vehicle Camera Lens Protective Cover according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to a lens protective cover and more particularly to a vehicle camera lens protective cover is structured and arranged to open in any direction that will improve protection, while allowing the camera to telescope out, if necessary, for a better wide-angle view.

Generally speaking, the Vehicle Camera Lens Protective Cover comprising a novel product offering consumers/manufacturers a practical solution to the aforementioned challenges. With the Vehicle Camera Lens Protective Cover, a user will prevent dust, dirt, mud, and more from fouling and damaging the vehicle's camera lens, so there will always be a clear view behind the vehicle. The Vehicle Camera Protective Lens Cover is structured and arranged to open in any direction that will improve protection, while allowing the camera to telescope out, if necessary, for a better wide-angle view. Again, even in muddy or messy weather, the user will not have to clean the lens to see what is behind the vehicle. The Vehicle Camera Lens Protective Cover is a simple and discreet way to keep your vehicle camera lens protected enabling a clean and clear image under any conditions. This, protective lens cover provides a significant safety feature as well.

Easy to use and packed with features and benefits:
Protects backup camera lens against outdoor elements
Sensor engages shutter to open and close when the vehicle is in reverse
Built into vehicle by the manufacturer
Color of the shutter cover matches the vehicle color for seamless blending
Practical design allows for easy installation on vehicle during manufacturing

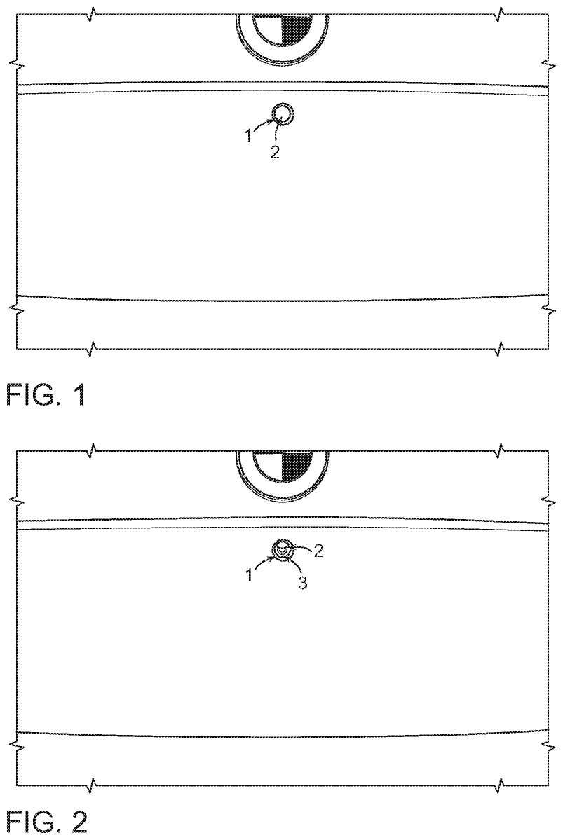

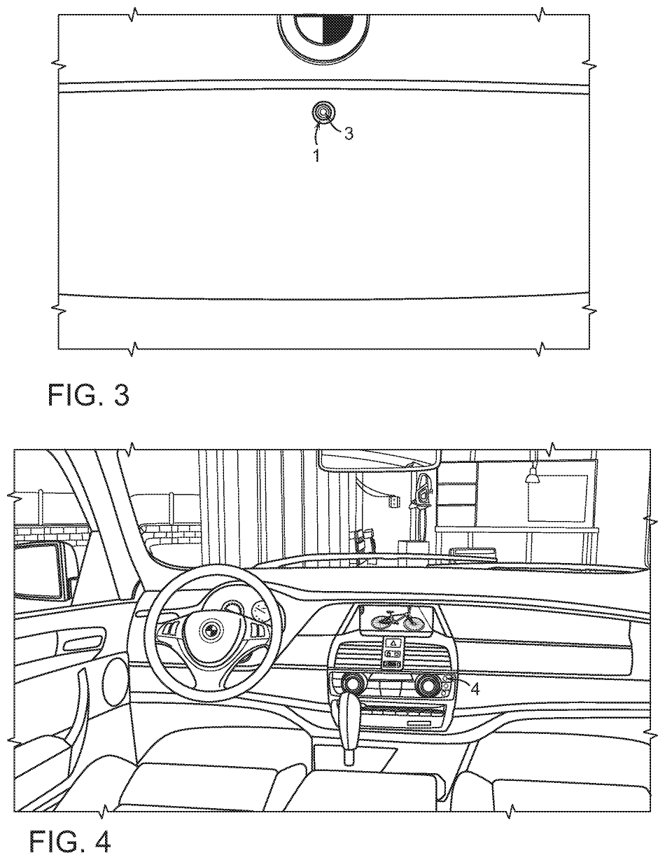

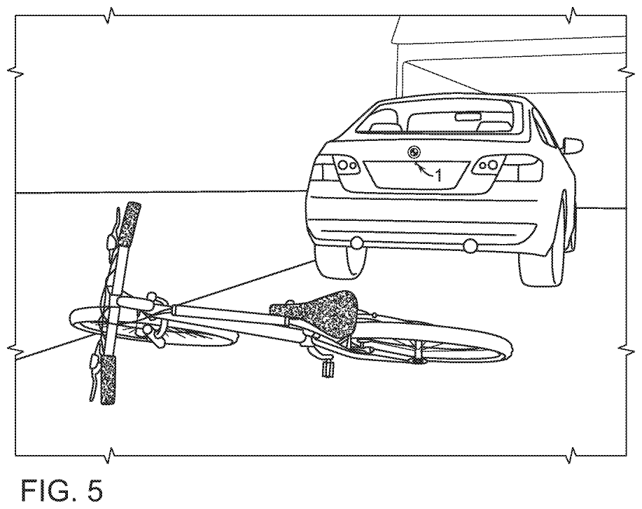

Referring to the drawings by numerals of reference there is shown in FIGS. 1-5 illustrating, perspective views illustrating vehicle camera lens 3 protective cover according to an embodiment of the present invention.

A vehicle camera lens 3 protective cover comprising: a cover including base part 1 and shutter part 2; sensor 4; a motor; and a heater operably connected to the cover and the motor to defrost the shutter part and the motor prior to opening. Wherein sensor 4 is operably connected to receive the signal to open or close shutter part 2 of cover 1. Wherein the motor is controllable by sensor 4 and operably connected to shutter part 2 of the cover to open or close shutter part 2 according to the signal received by the sensor 4. Wherein the heater is controllable by the signal received by sensor 4. Wherein the signal received by sensor 4 to open shutter part 2 indicates the user's vehicle is in reverse, and wherein the signal received by sensor 4 to close shutter part 2 indicates the user's vehicle is no longer in reverse. Wherein the heater operates immediately upon receipt of the open signal or the close signal by sensor 4, and wherein the motor operates to open shutter part 2 or close shutter part 2 three or four seconds after receipt of the open signal or close signal by sensor 4, so that the shutter part 2 and motor are heated by the heater prior to opening or closing shutter part 2 such as in instances of heavy frost, a delay to repeat the 3-4 seconds or independently adding seconds may be suitably used. Wherein the cover is color matched to the user's vehicle.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A vehicle camera lens protective cover comprising:
(a) a cover including a base part and a shutter part;
(b) a sensor, wherein the sensor is operably connected to receive the signal to open or close the shutter part of the cover; and
(c) a motor, wherein the motor is controllable by the sensor and operably connected to the shutter part of the cover to open or close the shutter part according to the signal received by the sensor.

2. The vehicle camera lens protective cover according to claim 1, wherein the signal received by the sensor to open the shutter part indicates the user's vehicle is in reverse, and wherein the signal received by the sensor to close the shutter part indicates the user's vehicle is no longer in reverse.

3. The vehicle camera lens protective cover according to claim 1, wherein the cover is color matched to the user's vehicle.

4. The vehicle camera lens protective cover according to claim 1, wherein the protective cover further comprises:
(d) a heater operably connected to the cover and the motor to defrost the shutter part and the motor prior to opening.

5. The vehicle camera lens protective cover according to claim 4, wherein the heater is controllable by the signal received by the sensor.

6. The vehicle camera lens protective cover according to claim 5, wherein the heater operates immediately upon receipt of the open signal or the close signal by the sensor, and wherein the motor operates to open the shutter part or close the shutter part three or four seconds after receipt of the open signal or close signal by the sensor, so that the shutter part and motor are heated by the heater prior to opening or closing the shutter part.

7. A vehicle camera lens protective cover comprising:
(a) a cover including a base part and a shutter part;
(b) a sensor, wherein the sensor is operably connected to receive the signal to open or close the shutter part of the cover;
(c) a motor, wherein the motor is controllable by the sensor and operably connected to the shutter part of the cover to open or close the shutter part according to the signal received by the sensor; and
(d) a heater operably connected to the cover and the motor to defrost the shutter part and the motor prior to opening,
wherein the heater is controllable by the signal received by the sensor,
wherein the signal received by the sensor to open the shutter part indicates the user's vehicle is in reverse, and wherein the signal received by the sensor to close the shutter part indicates the user's vehicle is no longer in reverse, and
wherein the heater operates immediately upon receipt of the open signal or the close signal by the sensor, and wherein the motor operates to open the shutter part or close the shutter part three or four seconds after receipt of the open signal or close signal by the sensor, so that the shutter part and motor are heated by the heater prior to opening or closing the shutter part.

8. The vehicle camera lens protective cover according to claim 7, wherein the cover is color matched to the user's vehicle.
